(19) United States
(12) Patent Application Publication
(10) Pub. No.: US 2003/0234004 A1
(43) Pub. Date: Dec. 25, 2003

(54) No-return loop fuel system

(76) Inventors: John R. Forgue, Cheshire, CT (US); Mark R. Johansen, Wallingford, CT (US)

Correspondence Address: REISING, ETHINGTON, BARNES, KISSELLE, P.C., P O BOX 4390, TROY, MI, 48099-4390, US

(21) Appl. No.: 10/443,159

(22) Filed: May 22, 2003

Related U.S. Application Data
(60) Provisional application No. 60/390,377, filed on Jun. 21, 2002.

(51) Int. Cl. F02M 1/00

(52) U.S. Cl. 123/460; 123/497

(57) ABSTRACT

A no-return loop fuel injection system supplies fuel from a turbine-type fuel pump to an injector fuel rail, through a fuel regulator valve capable of flowing supply fuel to the injector rail, and reverse flowing fuel from the rail and back through the pump to relieve rail fuel pressure. Preferably, the pressure regulator valve is of a diaphragm type biased closed via a spring disposed within a reference chamber defined between a housing and a side of the diaphragm and vented to atmosphere. A fuel chamber defined between an opposite side of the diaphragm and a valve body communicates between a pump-side port and a rail-side port. With the valve in a closed position, the fuel chamber is divided into a rail sub-chamber and a pump sub-chamber via the sealing relationship between a valve seat and the diaphragm, held closed by a closure biasing force of the spring. The valve moves to an open position when the hydraulic force generated by the fuel pressure generated force on the fuel chamber side exceeds the closure biasing force of the valve. The fuel hydraulic force is generally calculated as the product of the fuel pressure within the pump-side port times the area of an outer area of the diaphragm which defines in part the pump sub-chamber, plus the product of the residual fuel pressure within the rail-side port times an inner area of the diaphragm which defines in part the rail sub-chamber of the fuel chamber.

### REFERENCE TO RELATED APPLICATION

Applicant claims the benefit of provisional application Ser. No. 60/390,377, filed Jun. 21, 2002.

### FIELD OF THE INVENTION

This invention relates to automotive engine fuel systems and more particularly to a no-return loop fuel system having a variable speed fuel pump.

### BACKGROUND OF THE INVENTION

There are two general types of a no-return loop or returnless fuel injection systems for a combustion engine. The first type, referred to as a “T” configuration, is used in fuel system applications where the fuel pressure within an injector fuel rail is held constant regardless of the mass fuel amount flowing through the injectors. The second type is referred to as a “parallel” configuration and is particularly popular in fuel systems requiring varying fuel pressure within the injector fuel rail dependent upon a particular engine transient. For instance, turbo-charged engines often require injector fuel rail pressures at wide open throttle conditions which are twice that at idle or engine coasting conditions. Both types commonly utilize a cycling or variable speed fuel pump which varies and controls fuel pressure via a pressure signal generated at the fuel rail.

The “T” configuration 10, as best shown in FIG. 1 as prior art, supplies fuel to an injector fuel rail 12 through a flow check valve 14 at the outlet of a variable speed fuel pump 16. The flow check valve 14 will close when fuel pressure at the outlet of the flow check valve exceeds the fuel pressure at the inlet of the flow check valve or pump outlet 18. The flow check valve will typically close when the engine is shut-off, thereby, preventing fuel vaporization and preserving liquid fuel and pressure within the rail 12 for reliable engine start-up. Orientated between the flow check valve and the fuel rail 12 of the “T” configuration 10 is a pressure relief check valve 20 for bleeding fuel directly back to the fuel tank in the event the fuel rail and injectors are subject to an overpressure condition. The pressure relief check valve 20 is designed to typically open when fuel pressure at the fuel rail 12 or inlet 22 of the pressure relief check valve 20 exceeds a predetermined value which is higher than the normal operating pressure at the fuel rail 12. For instance, an overpressure condition may be caused after engine shutdown, wherein the flow check valve 14 is closed and the resultant trapped fuel within the fuel rail 12 rises in pressure with increasing fuel temperature possibly heated by the residual heat emanating from the hot engine or surrounding environment. Yet another scenario of an overpressure condition may be caused by a slow response time of the variable speed pump. For instance, when an engine running at wide open throttle is immediately decelerated into a coasting condition, the injectors may thus close for seconds at a time. This could cause a pressure spike if the variable speed fuel pump can not immediately respond thus the pressure relief check valve will open to relieve fuel pressure at the rail.

Unfortunately, because the pressure relief check valve is referenced to tank pressure as opposed to pump output pressure the relief set pressure of the “T” configuration must be set well above system operating pressure. As a result, the range of pressure control within the fuel rail is limited. A second disadvantage of the “T” configuration is that a separate bypass line and associated fittings are required thus increasing the manufacturing costs and assembly required. The “T” configuration also has a disadvantage of returning fuel overage directly to the fuel tank which may result, particularly under high temperature conditions, in the fuel pump continuously pumping fuel through the pressure relief check valve and back into the fuel tank.

The second or “parallel” configuration, as disclosed in U.S. Pat. Nos. 5,361,742 (Briggs et al.) and 5,477,829 (Hassinger et al.), which is probably the most current type of fuel injection system, also utilizes a variable speed fuel pump which varies speed and thus fuel flow based on a fuel pressure input signal from the fuel rail. Unlike the “T” configuration, the “parallel” configuration utilizes a flow check valve and a pressure relief check valve orientated in parallel to one another at the outlet of the pump. During operation of a combustion engine employing the “parallel” configuration, no-return loop, fuel injection system, the flow check valve at the outlet of the fuel pump opens with minimal differential pressure when fuel is supplied to the fuel injector rail, and closes to prevent reverse flow of fuel when the pressure at the flow check valve outlet (or pressure at the rail) is greater than the outlet pressure at the pump (or inlet pressure to the flow check valve). If the pressure at the outlet of the flow check valve exceeds a predetermined value referenced to the outlet of the pump usually during long deceleration periods, the parallel pressure relief check valve will open and fuel will reverse flow through the idle pump. To reduce this excessive fuel pressure at the rail, the normally closed pressure relief check valve opens from a normally closed position while the flow check valve remains closed. The pressure relief setpoint is greater than that of the flow check valve and is typically approximately the minimum value required to operate the engine and keep the fuel in the fuel rail from completely vaporizing during engine shut down. When the pressure relief check valve is open, fuel bleeds back from the fuel rail and through the outlet side of the fuel pump. This “parallel” configuration contrasts with the pressure relief check valve of the “T” configuration where the opening setpoint pressure of the pressure relief check valve is above the maximum running pressure of the fuel rail and the fuel bleed back is not through the fuel pump.

Unfortunately, the parallel combination of the pressure relief check valve and the flow check valve requires many moving parts and thus is expensive to manufacture and maintain. Moreover, both valves are typically of a poppet design. The flow check valve has a ball bearing as a head which engages a seat under its own weight when closed. The pressure relief check valve is similar but typically is assisted by the force of a spring to further bias the ball bearing against the seat. Unfortunately, poppet valves are prone to wear and high frequency pressure fluctuations, as best shown in FIG. 7, which can degrade the smooth running performance of an engine.

### SUMMARY OF THE INVENTION

A no-return loop fuel injection system supplies fuel from a turbine-type fuel pump to an injector fuel rail, through a fuel regulator valve capable of flowing supply fuel to the injector rail, and reverse flowing fuel from the rail and back through the pump to relieve rail fuel pressure. Preferably, the pressure regulator valve is of a diaphragm type biased closed via a spring disposed within a reference chamber defined between a housing and a side of the diaphragm and vented to atmosphere. A fuel chamber defined between an opposite side of the diaphragm and a valve body communicates between a pump-side port and a rail-side port. With the valve in a closed position, the fuel chamber is divided into a rail sub-chamber and a pump sub-chamber via the sealing relationship between a valve seat and the diaphragm, held closed by a closure biasing force of the spring. The valve moves to an open position when the hydraulic force generated by the fuel pressure on the fuel chamber side exceeds the closure biasing force of the valve. The hydraulic force is generally calculated as the product of the fuel pressure within the pump-side port times the area of an outer area of the diaphragm which defines in part the pump sub-chamber, plus the product of the residual fuel pressure within the rail-side port times an inner area of the diaphragm which defines in part the rail sub-chamber of the fuel chamber.

Preferably, the fuel pump is a variable speed pump which is controlled via a computer receiving an input from a pressure transducer at the rail. Preferably, the closure biasing force is substantially equal to the minimum or idling fuel pressure at the rail times the area of the inner area of the diaphragm.

Objects, features and advantages of this invention are to provide a no-return loop fuel system which utilizes a reverse flowing valve to control fuel pressure delivered to the injectors during various engine operating conditions and preserve fuel pressure within the system at a minimal value during engine shut down. The system avoids supplying excessive fuel to the engine under certain operating conditions, decreases engine emissions, decreases the number of parts, and is rugged, durable, maintenance free, of relatively simple design and economical manufacture and assembly, and in service has a long useful life.

### DESCRIPTION OF THE DRAWINGS

These and other objects, features and advantages of this invention will be apparent from the following detailed description, appended claims, and accompanying drawings in which:

FIG. 1 is a schematic of a prior art, no-return-loop, “T” configuration, fuel injection system;

FIG. 2 is a schematic of a no-return loop, “parallel” configuration fuel injection system of the present invention;

FIG. 3 is a cross section of a pressure relief valve of the no-return loop fuel injection system shown in an open position;

FIG. 4 is a plan view of the pressure relief valve with portions removed to show internal detail;

FIG. 5 is a cross section of the pressure relief valve similar in perspective to FIG. 3 except the valve is shown in a closed position;

FIG. 6; is a graph of a fuel pressure transient within a fuel rail of the no-return loop fuel injection system utilizing a preferred diaphragm type pressure relief valve; and

FIG. 7 is a graph of a fuel pressure transient within a fuel rail of a no-return loop fuel injection system utilizing a poppet-type pressure relief valve.

### DETAILED DESCRIPTION OF THE PREFERRED EMBODIMENTS

As best illustrated in FIG. 2 a no-return loop fuel system 20 of the present invention has a variable speed turbine fuel pump 22 preferably disposed within a fuel tank 24 which delivers fuel to a series of injectors 26 to operatively deliver fuel from a common manifold tube or fuel rail 28 to respective combustion chambers of an engine 23. The speed of the fuel pump 22 is controlled via a computer or a controller 30 (preferably part of the vehicle engine central programming unit) which receives an input signal 32 from a pressure transducer 34 mounted on the fuel rail 28 which then processes the signal and outputs a speed control signal 36 to the pump 22. Preferably, the pressure at the fuel rail 28 varies depending upon engine speed or consumption demand and any other of a variety of engine parameters processed by the controller 30.

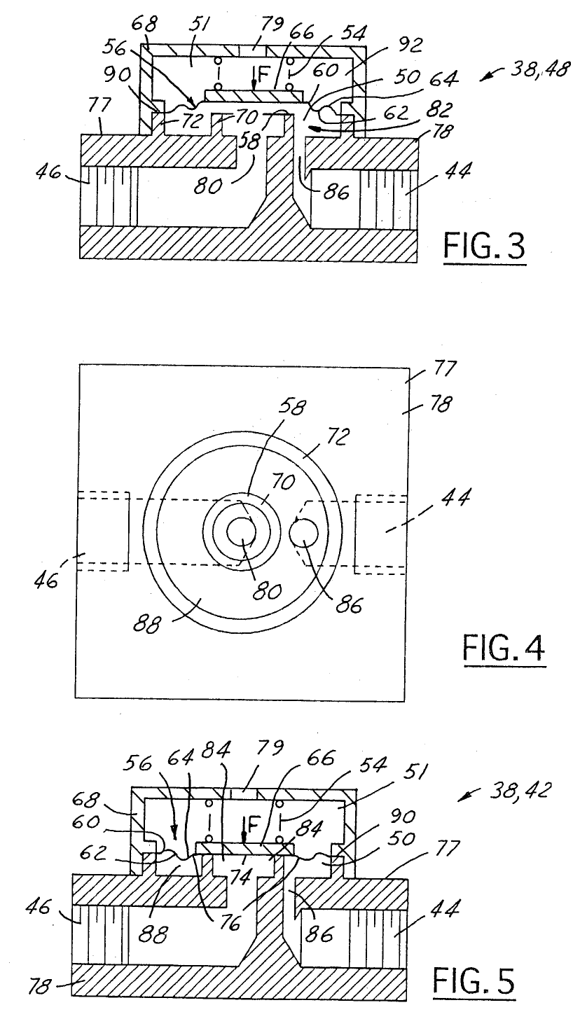

A pressure regulator valve 38 is interposed in a fuel line 40 communicating between the fuel pump 22 and the engine 23 or fuel rail 28. Because valve 38 is capable of fuel flow in either direction, and thus is not a check valve, a return fuel line for reducing pressure at the rail or any point in between is not required. When valve 38 is in a closed position 42 (FIG. 5), a pump-side port 44 of the pressure regulator valve 38 is isolated from an engine-side or rail-side port 46 of the valve. When the pressure regulator valve 38 is in an open position 48 (FIG. 3), fuel may flow in either direction through the valve, depending on the needs of the fuel system 20.

In operation, and prior to starting of the engine 23, residual fuel pressure within the fuel rail 28 should be near or substantially below idling pressure. Any pressure increases of the trapped fuel within the rail caused by residual heat from the engine or heat generated within the engine compartment, caused for instance by the vehicle standing exposed to the heat of a hot day, is relieved by the pressure regulator valve 38 opening to flow fuel from the rail and back through an impeller cavity 25 of the pump 22. To move from the closed to the open positions 42, 48, the force exerted by the residual fuel pressure at the rail-side port 46 must exceed the closure biasing force F of the valve 38 which holds the valve normally closed if the fuel pressure at the pump-side port 44 is at atmospheric or reference pressure. Otherwise, positive residual fuel pressure at the pump-side port 44, even though its less than the residual pressure at the rail-side port 46, will assist to open the valve 38 to relieve fuel pressure at the rail 28. Preferably, the valve 38 is vented to atmosphere or to near atmospheric pressure should the valve 38 be mounted within the fuel tank 24.

When the engine 23 is first started, the pump 22 begins to flow supply fuel, and the injectors 26 begin to cycle open. The pump-side port pressure will surge to meet the fuel demand of the cycling open injectors 26. The force exerted by the surging fuel pressure at the pump-side port 44 coupled with the force exerted by the residual fuel pressure at the rail-side port 46 will open the valve 38 once the combined forces exceed the biasing force F of the valve 38. Once the engine 23 is started, and with the fuel regulator valve 38 open, the speed of the pump 22 will adjust or level-off to maintain idling or minimum fuel pressure at the rail 28 assuming the engine is at idling condition.

For enhanced fuel systems, during start-up, the fuel injectors 26 will not begin to cycle open until the fuel pressure within the fuel rail reaches minimum idling pressure. Therefore, the pump 22 will initiate first, and the injectors 26 will only cycle open after idle operating pressure is reached at the rail 28. This sequencing is especially preferable when hot trapped fuel within the rail 28 has been relieved of pressure through the fuel regulator valve 38 to idling pressure and then the fuel cools dropping further in pressure to a reduced residual pressure, well below necessary idling pressure. Any fuel leakage through the injectors can only aggravate this condition by dropping the residual pressure even further. In any event, the residual fuel pressure within the rail 28 theoretically remains high enough to prevent the vaporization of fuel or air ingress into the fuel rail which could hinder start-up and cause rough idling conditions. Similarly, for enhanced fuel systems, during start-up, the area of the valve 38 which communicates with the rail 28 and the area of the valve 38 that communicates with the pump 22 can be sized and the biasing force F can be specified such that the fuel pressure maintained in the fuel rail when the engine 23 is off is equal to or higher than operating pressure. This condition minimizes the generation of vapor in the fuel rail 28 during hot engine off conditions.

Preferably, as the engine speed increases, fuel flow increases and the required fuel pressure within the fuel rail 28 increases. This increase in pressure is especially true for turbo-charged engines where the rail pressure at wide open throttle conditions is typically approximately twice the required rail pressure at idle. When an engine is running at wide open throttle conditions and is suddenly decelerated to a coasting engine condition, the injectors 26 may remain suddenly closed for seconds at a time. Although the fuel pump 22 may effectively stop, high fuel pressures within the rail must still be relieved to substantially reduce rail pressure to idling pressures. Excessive heat from the engine 23 will aggravate this overpressure condition. Therefore, fuel must flow from the rail through the open pressure regulator valve 38, and back through the impeller cavity 25 of the idle pump 22. The reaction time for this pressure drop scenario is quick because the pressure regulator valve 38 is believed to never actually close from its open position 48 during the wide open throttle condition of the engine. That is, the force exerted by the fuel pressure at the pump-side port 44 plus the force generated by the fuel pressure at the rail-side port 46 never drops below the closure biasing force F of the valve 38, which as previously described is substantially near the necessary fuel idling pressure at the rail.

When the engine 23 is shut down, the injectors 26 stop cycling open and the pump stops. The pressure regulator valve 38 remains in its open position 48 until the force exerted by the fuel pressure at the rail-side port 46 equals or is slightly less than the closure biasing force F of the pressure regulator valve 38 at which point the valve moves to the closed position 42. This assumes the fuel pressure at the pump-side port 44 drops to substantially atmospheric pressure and the valve 38 is vented to atmosphere.

Referring to FIGS. 3-6, the ports 44, 46 communicate with each other via an interposing fuel chamber 50 defined generally between a body 78 of the valve 38 and a valve head or resilient diaphragm assembly 56 when the valve is in the open position 48. Preferably, the pressure regulator valve 38 is passive and biased in the closed position 42 by a spring 54 having a known coefficient of compression or spring constant thus exerting a known force upon the diaphragm assembly 56 which sealably engages to a valve seat 58.

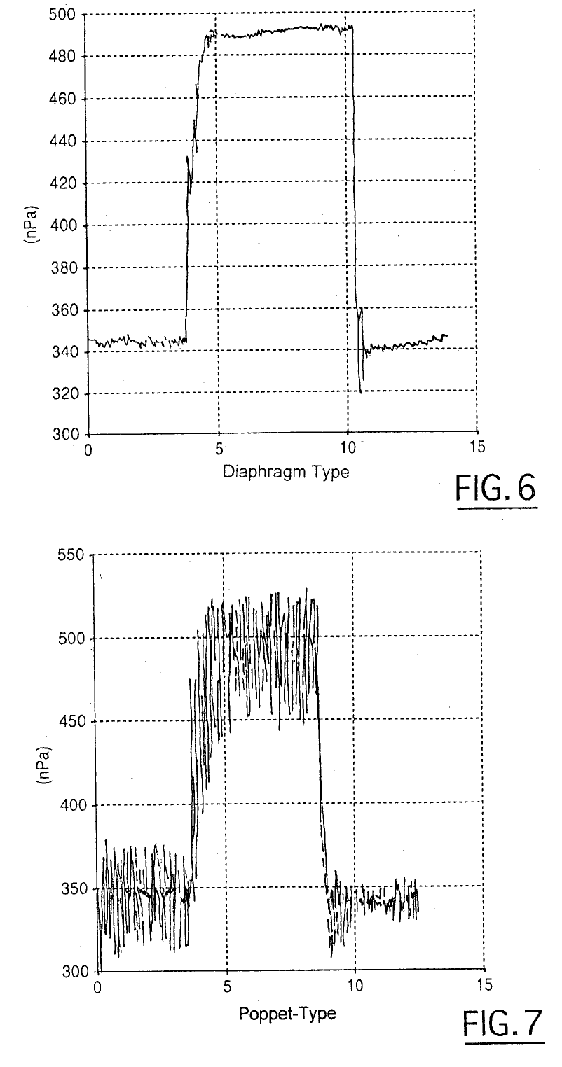

The valve head 56 may take the form of a poppet-type or ball bearing head. However, as shown in FIG. 7, poppet valves tend to oscillate excessively creating pressure spikes within the fuel rail which could degrade smooth running performance of an engine. In contrast, the performance of the preferred diaphragm type valve 38, as shown in FIG. 6, has a much smoother yet equally responsive performance curve. As opposed to poppet valve designs which are always moving, causing oscillations in fuel pressure at the rail, the diaphragm design relieves these transients creating a smoother running engine, with less noise and less wear.

The valve head 56 has a resilient diaphragm 60 having a fuel side 62 and a reference side 64. The fuel chamber 50 is defined between a valve body 78 which carries the ports 44, 46 and the fuel side 62 of the diaphragm 60, and a reference chamber 51 is defined between the reference side 64 of the diaphragm 60 and a housing 68. Preferably, a substantially rigid member 66 is engaged to the reference side 64 of the diaphragm 60 to support the spring 54 which is compressed axially or biased between the valve housing 68 and the rigid member 66 within the reference chamber 51. The spring 54 assures reliable seating of the diaphragm 60 against the valve seat 58.

The valve seat 58 is substantially annular in shape and is carried by the distal end of an inner shoulder 70 projecting upward from a surface 77 of the valve body 78. An outer shoulder 72 is concentrically disposed to and radially outward from the inner shoulder 70 and sealably engages both the housing 68 and a peripheral edge 90 of the diaphragm 60.

An inner orifice 80 carried by the surface 77 of the body 78 communicates between the fuel chamber 82, defined by the surface 77 and the fuel side 62 of the diaphragm 60, and the rail-side port 46. When the valve is in the closed position 42, the inner orifice 80 communicates solely with a rail sub-chamber 84 of the fuel chamber 82 which is defined in part by a first area 74 or inner portion of the fuel side 62 of the diaphragm 60 and a substantially circular portion of the surface 77 of the body 78 disposed radially inward from the first seat 70. An outer orifice 86 carried by an annular portion of the surface 77 disposed between the shoulders 70, 72 of the body 78 communicates between a pump sub-chamber 88 of the fuel chamber 82 disposed radially outward from the rail sub-chamber 84 and segregated therefrom by the inner shoulder 70 or seat 58. The pump sub-chamber 88 is defined in-part by the substantially annular shaped second area 76 or outer portion of the fuel-side 62 of the diaphragm 60 and the annular portion of the surface 77 of the body disposed radially between the shoulders 70, 72.

For the valve 38 to open, the total hydraulic force exerted on the fuel-side 62 of the diaphragm 60 must be greater than the total closure biasing force F exerted on the reference side 64 which is substantially the spring force (produced by spring 54) plus that force generated by the air pressure within the reference chamber 51. Preferably, the reference chamber 51 is vented to atmosphere via the orifice 79 carried by the housing 68, so that the closure biasing force F is substantially the spring force alone. However, the reference chamber 51 can be vented to other areas such as the vacuum manifold, the fuel tank, or the inlet to the fuel pump to vary the pressure in chamber 51 which could potentially correlate the valve operation with varying dynamics of the engine.

Assuming the reference chamber 51 is vented to atmosphere and the engine 23 is shut off so that the pump-side port 44 is substantially at atmospheric pressure, the pressure regulator valve 38 will remain in the normally closed position 42 unless the biasing force F is exceeded by the hydraulic force calculated generally as the residual fuel pressure within the fuel rail 28 or rail-side port 46 times the exposed or circular area 74. Once the hydraulic force exceeds the biasing force F, the valve 38 will initially crack open to relieve pressure until once again the hydraulic force decreases to slightly below the closure biasing force F.

During engine start-up, the pressure regulator valve 38 will remain in its normally closed position 42 until the biasing force F is exceeded by the opposing hydraulic force which is generally calculated as the summation of the product of the residual pressure at rail-side port 46 times the area of the circular area 74 plus the product of the fuel pressure at the pump-side port 44 times the area of the annular area 76. Once the hydraulic force exceeds the biasing or spring force F, the valve 38 will initially open. The valve will then remain open provided the hydraulic pressure calculated as the fuel pressure within the fuel chamber 50 times the total area of the fuel side 62 of the diaphragm 60 remains in excess of the closure biasing force F.

During design, the size of inner area 74, or the ratio of area 74 over the total exposed area of diaphragm side 62 must be sized in comparison to the closure biasing force F so that the valve 38 will open if the rail pressure exceeds minimum idling pressure. Moreover, area 74 exposed generally to the rail-side port 46 is smaller than area 76 exposed generally to the pump-side port 44. This means during start-up of the engine 23, and after a long shutdown period, so that residual pressure at the rail is near zero or atmospheric, it takes less pressure to open the valve 38 to supply fuel to the rail 28, than it takes to open the valve 38 to relieve residual pressure from the rail 28 flowing fuel back to the idle pump 22.

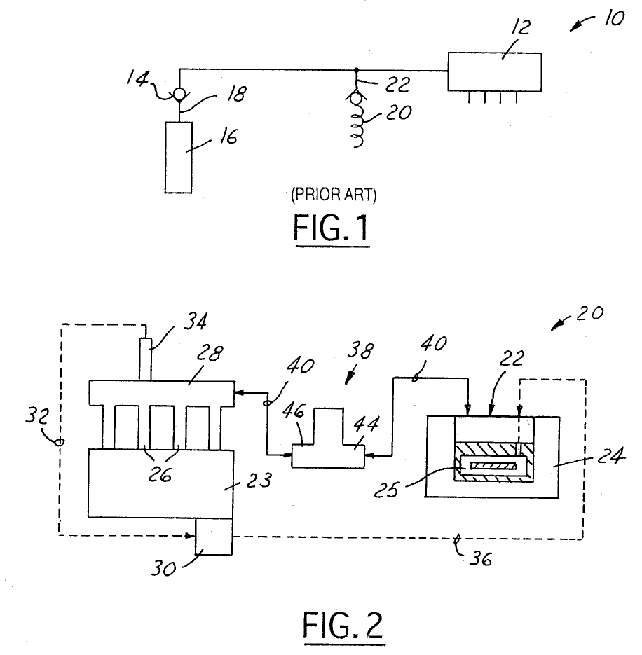

For a turbo-charged engine system operating under variable pressure conditions, required fuel rail pressure at wide open throttle can be five bars while desired engine idling pressure at the fuel rail is two and a half bars. Conventional, no-return loop, “T” configuration, fuel injection systems as shown in FIG. 1, require the pressure relief check valve 20 to actuate above five bars. The pressure regulator valve 38 of the no-return loop, “parallel” configuration, fuel injection system 20 requires a pressure regulator valve 38 setting of only two and a half bars to flow fuel even in the relief or reverse direction. Therefore, when the engine 23 is shut down, fuel rail pressure immediately falls to two and a half bars as opposed to holding at five bars for the prior art system which would therefore be more prone to fuel leakage through the injectors and unwanted rich engine start scenarios. Regardless, the pressure regulator valve 38 of the present invention can replace the flow check valve 14 at the outlet 18 of the pump 16 of a conventional “T” configuration fuel injection system 10. With this application, the fuel rail of the “T” configuration system need not be exposed to high internal fuel pressures when the engine is shut down. This has the benefit of reducing the likelihood of injector fuel leakage.

While the forms of the invention herein disclosed constitute a presently preferred embodiment, many others are possible. For instance, the pressure regulator valve can be replaced with a servo or pneumatic controlled valve which operates via the controller and pressure signals received from the transducer at the rail and an additional transducer positioned at the outlet of the fuel pump. It is not intended herein to mention all the possible equivalent forms or ramification of the invention. It is understood that terms used herein are merely descriptive, rather than limiting, and that various changes may be made without departing from the spirit or scope of the invention.

We claim:

1. A no-return loop fuel delivery system for a combustion engine comprising:
a fuel pump;
a fuel rail assembly having a fuel injector for injecting fuel into the combustion engine;
a pressure regulator valve constructed and arranged to flow fuel between the fuel rail assembly and the fuel pump, the pressure regulator valve having a pump-side port, a rail-side port, an open position, a closed position, and a closure biasing force, the pump-side port being positioned between the fuel pump and the rail-side port, the rail-side port being positioned between the pump-side port and the fuel rail;
wherein the pressure regulator valve moves from the closed position to the open position to flow fuel from the fuel pump through the ports and to the fuel rail when the closure biasing force is exceeded by an opposing hydraulic force generated by fuel pressure; and
wherein the pressure regulator valve moves from the closed position to the open position to flow fuel from the fuel rail through the ports and back through the fuel pump when the closure biasing force is exceeded by the opposing hydraulic force generated by fuel pressure.

2. The no-return loop fuel delivery system set forth in claim 1 wherein a one-way flow check valve is not constructed and arranged to operate between the fuel rail assembly and the fuel pump.

3. The no-return loop fuel delivery system set forth in claim 1 wherein the fuel pump is a variable speed fuel pump.

4. The no-return loop fuel delivery system set forth in claim 2 wherein the fuel pump is a variable speed fuel pump.

5. The no-return loop fuel delivery system set forth in claim 4 comprising:
a pressure transducer for measuring fuel pressure within the fuel rail assembly; and
a controller for receiving and processing a pressure signal from the pressure transducer and sending a speed command signal to the variable speed fuel pump.

6. The no-return loop fuel delivery system set forth in claim 1 wherein the pressure regulator valve is of a diaphragm-type.

7. The no-return loop fuel delivery system set forth in claim 6 wherein the pressure regulator valve comprises:
a body;
a resilient diaphragm having a peripheral edge engaged sealably to the body;
a fuel chamber defined between the body and the diaphragm;
a rail-side port carried by the body and communicating with the fuel chamber;
a pump-side port carried by the body and communicating with the chamber; and
wherein the rail-side port communicates with the pump-side port when the regulator valve is in the open position, and wherein the diaphragm obstructs communication between the rail-side port and the pump-side port within the fuel chamber when the valve is in the closed position.

8. The no-return loop fuel delivery system set forth in claim 7 comprising:
a housing engaged sealably to the peripheral edge of the diaphragm and the body;
a reference chamber defined between the housing and a reference side of the diaphragm; and
wherein the fuel chamber is defined between an opposite fuel side of the diaphragm and the body.

9. The no-return loop fuel delivery system set forth in claim 8 comprising:
a spring disposed within the reference chamber and compressed resiliently between the diaphragm and the housing; and
wherein the closure biasing force is the force of the spring plus the product of the reference chamber pressure times the area of the exposed reference side of the diaphragm.

10. The no-return loop fuel delivery system set forth in claim 9 comprising:
a valve seat exposed within the fuel chamber and seated sealably against the fuel side of the diaphragm when the pressure regulator valve is in the closed position;
the fuel side of the diaphragm having a first area and a second area;
a pump sub-chamber of the fuel chamber defined between the body and the first area of the diaphragm; and
a rail sub-chamber of the fuel chamber defined between the body and the second area of the diaphragm, wherein the rail sub-chamber is isolated from the pump sub-chamber when the valve seat is engaged to the diaphragm.

11. The no-return loop fuel delivery system set forth in claim 10 wherein the reference chamber is vented to atmospheric pressure.

12. The no-return loop fuel delivery system set forth in claim 10 wherein the first area is larger than the second area.

13. The no-return loop fuel delivery system set forth in claim 10 wherein the valve seat is annular in shape and the rail sub-chamber is disposed radially inward of the valve seat.

14. The no-return loop fuel delivery system set forth in claim 13 wherein the body has a cylindrical shoulder disposed within the fuel chamber and carrying the annular valve seat.

15. A pressure regulator valve for a no-return loop fuel delivery system having a fuel injector for operatively flowing fuel into a combustion engine and a fuel pump for flowing pressurized fuel to the injector through the pressure regulator valve, the pressure regulator valve comprising:
a body;
a pump-side port carried by the body;
an engine-side port carried by the body, wherein the pump-side port is positioned between the fuel pump and the engine-side port, the engine-side port being positioned between the pump-side port and the fuel injector;
a valve seat carried by the body and disposed between the engine-side and pump-side ports; and
a valve head biased sealingly against the valve seat when the valve is in a closed position thereby isolating the engine-side port from the pump-side port, the valve head having a first area exposed to the pump-side port and a second area exposed to the engine-side port.

16. The pressure regulator valve set forth in claim 15 wherein the valve head is biased against the valve seat by a spring.

17. The pressure regulator valve set forth in claim 16 comprising:
a housing engaged to the body; and
a reference chamber defined between the valve head and the housing, the reference chamber being isolated from the engine-side and pump-side ports regardless of whether the valve is in the closed or open position.

18. The pressure regulator valve set forth in claim 17 wherein the valve head has a resilient diaphragm having a peripheral edge engaged sealably to the body.

19. The pressure regulator valve set forth in claim 18 comprising:
a fuel chamber defined between the body and the diaphragm; and
wherein the engine-side port communicates with the pump-side port via the fuel chamber when the regulator valve is in the open position, and wherein the diaphragm obstructs communication between the engine-side port and the pump-side port within the fuel chamber when the valve is in the closed position.

20. The pressure regulator valve set forth in claim 19 comprising a spring disposed within the reference chamber and compressed resiliently between the diaphragm and the housing.

21. The pressure regulator valve set forth in claim 20 wherein the reference chamber is vented to atmospheric pressure.
